(19) United States
(12) Patent Application Publication
(10) Pub. No.: US 2026/0270887 A1
(43) Pub. Date: Sep. 10, 2026

(54) WIRELESS POWER CONTROL TECHNIQUES

(71) Applicant: ZTE Corporation, Shenzhen (CN)

(72) Inventors: Bo GAO, Shenzhen (CN); Zhaohua LU, Shenzhen (CN); Ke YAO, Shenzhen (CN); Xiaolong GUO, Shenzhen (CN); Yang ZHANG, Shenzhen (CN)

(21) Appl. No.: 19/656,651

(22) Filed: Apr. 23, 2026

Related U.S. Application Data
(63) Continuation of application No. PCT/CN2023/128555, filed on Oct. 31, 2023.

(51) Int. Cl. H04W 52/32; H04W 52/08; H04W 52/24; H04W 52/42

(52) U.S. Cl. CPC H04W 52/325; H04W 52/08; H04W 52/242; H04W 52/42

(57) ABSTRACT

Techniques are described to communicate according to a beam state. An example wireless communication method includes receiving, by a communication device, one or more beam states, where at least one beam state of the one or more beam states is associated with a channel or a reference signal; and communicating, by the communication device, the channel or the reference signal according to the at least one beam state.

### CROSS-REFERENCE TO RELATED APPLICATIONS

This application is a continuation of International Patent Application No. PCT/CN2023/128555, filed on Oct. 31, 2023, the contents of which are incorporated herein by reference in their entirety.

### TECHNICAL FIELD

This document is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

Techniques are disclosed handling uplink (UL) power control and beam state indication for an example scenario of asymmetric downlink (DL) single transmission and reception point (sTRP) and UL multiple transmission and reception point (mTRP). Specifically, techniques are described for an example architecture of beam state indication for enabling a single DL beam state indication but one or more UL beam state indication; for time division duplex (TDD) channel state information (CSI) acquisition, a separate closed loop for sounding reference signal (SRS) to DL TRP and corresponding independent power headroom report (PHR) for the SRS regardless of whether there is physical uplink shared channel (PUSCH) configuration or not, and finally pathloss (PL) measurement being based on SRS reception and corresponding transmission power and PL/PL-offset configuration are proposed for handling an issue of the misalignment of measurement being based on another reference signal (RS) not from UL-TRP or based on an absence of PL RS configuration.

A first example wireless communication method includes receiving, by a communication device, one or more beam states, where at least one beam state of the one or more beam states is associated with a channel or a reference signal; and communicating, by the communication device, the channel or the reference signal according to the at least one beam state.

In some embodiments, the one or more beam states comprise any one or more of: a downlink beam state and an uplink beam state, a joint beam state and one or more uplink beam states, a downlink beam state and one or more uplink beam states, one or more downlink beam states and one or more uplink beam states, or one or more joint beam states. In some embodiments, the method comprises at least one of: the communication device receives a radio resource control (RRC) parameter associated with a mode; the joint beam state is applied to both downlink and uplink; the downlink beam state is applied to downlink; or the uplink beam state is applied to uplink. In some embodiments, the one or more beam states comprises two or more downlink beam states or two or more joint beam states, and the method further comprises any one or more of: the two or more downlink beam states or the two or more joint beam states belong to a same beam state or a same quasi colocation (QCL) property; a first downlink beam state of the two or more downlink beam states or a first joint beam state of the two or more joint beam states is applied to downlink; or one or more second downlink beam states of the two or more downlink beam states or one or more second joint beam states of the two or more joint beam states are ignored or not applied to downlink.

In some embodiments, the at least one beam state from the one or more beam states comprises a joint beam state or an uplink beam state, and the reference signal comprises a sounding reference signal (SRS). In some embodiments, the SRS is used for antenna switching, the SRS is used for channel-state-information (CSI) acquisition, or the SRS is associated with a separate closed loop. In some embodiments, the at least one beam state from the one or more beam states comprises a joint beam state or an uplink beam state, and the reference signal comprises a sounding reference signal (SRS) that is not used for antenna switching, is not used for channel-state-information (CSI) acquisition, or is not associated with a separate closed loop. In some embodiments, the method further comprises any one or more of: the channel comprises a physical downlink shared channel (PDSCH) applying a first downlink beam state or a first joint beam state; the channel comprises a control resource set (CORESET) applying a first downlink beam state or a first joint beam state; the reference signal comprises a channel state information reference signal (CSI-RS) applying a first downlink beam state or a first joint beam state; the channel comprises a physical uplink shared channel (PUSCH) applying a first uplink beam state and/or a second uplink beam state, or a first joint beam state and/or a second joint beam state; the channel comprises a physical uplink control channel (PUCCH) applying a first uplink beam state and/or a second uplink beam state, or a first joint beam state and/or a second joint beam state; or the reference signal comprises a sounding reference signal (SRS) applying a first uplink beam state and/or a second uplink beam state, or a first joint beam state and/or a second joint beam state.

In some embodiments, the first downlink beam state or the first joint beam state is associated with a first flag or a first index in the one or more beam states; the first uplink beam state or the first joint beam state is associated with a first flag or a first index in the one or more beam states; or the second uplink beam state or the second joint beam state is associated with a second flag or a second index in the one or more beam states. In some embodiments, a first joint beam state is not allowed to be applied to a physical uplink shared channel (PUSCH); a first joint beam state is not allowed to be applied to a physical uplink control channel (PUCCH); or a second joint beam state is not allowed to be applied to a sounding reference signal (SRS) for antenna switching or DL CSI acquisition. In some embodiments, the reference signal comprises a sounding reference signal (SRS) associated with a separate closed loop in a component carrier, and the method further comprises: receiving, by the communication device, a control information, the control information includes a transmission power command (TPC) for the SRS, the transmission power of the SRS in the component carrier is determined according to the TPC.

In some embodiments, the method further comprises any one or more of: a mode indicating that a single downlink beam state and one or more uplink beam states are indicated is enabled; an index of the separate closed loop is configured per SRS resource set; or the SRS is associated with the separate closed loop that is separated from that of a physical uplink shared channel (PUSCH). In some embodiments, a physical uplink shared channel (PUSCH) is configured in the component carrier. In some embodiments, the SRS is associated with different beam state or different beam states from that of PUSCH.

In some embodiments, one field in the control information indicates a closed-loop index for the TPC. In some embodiments, the method further comprises any one or more of: the field comprises zero bit in response to only one separate closed loop for the SRS being configured; the control information indicates a list of closed loop index for respective closed loops; the control information indicates a list of blocks, each of block comprising a closed loop index and a TPC; or there are one or more TPC fields in the control information, and the closed loop index is applied for the one or more TPC fields. In some embodiments, a closed loop associated with the TPC is determined according to at least one of the following: a control resource set (CORESET) or a search space set associated with the control information, a time unit of the control information, or a cell, a carrier component, or a bandwidth part (BWP) associated with the control information. In some embodiments, the closed loop associated with the TPC is determined according to whether the control information is in a first time unit or a second time unit; or the closed loop associated with the TPC is determined according to whether the control information is in an odd time unit or an even time unit.

In some embodiments, the method further comprises associating, by the communication device, the at least one beam state with a timing advance group (TAG) index and/or a power control parameter, a communication of the channel or the reference signal in the component carrier is determined according to the TAG index or the power control parameter. In some embodiments, the power control parameter includes a power offset or a pathloss value; or the at least one beam state is associated with the power offset or the pathloss value by a radio resource control (RRC) or a medium access control-control element (MAC-CE). In some embodiments, the power offset comprises a power offset value or a power offset index. In some embodiments, the power control parameter includes a power offset, and a transmission power with which the communication is performed is according to a pathloss estimate of a pathloss reference signal (PL-RS) associated with the at least one beam state and the power offset.

In some embodiments, the power control parameter includes a pathloss value, and further comprising any one or more of: the at least one beam state is not associated with a pathloss reference signal (PL-RS); or the PL-RS associated with the at least one beam state is absent, ignored or precluded. In some embodiments, the method further comprises transmitting, by the communication device, a signaling carrying an information related to a sounding reference signal (SRS) transmission power, the signaling comprising a radio resource control (RRC) or medium access control-control element (MAC-CE).

A second example wireless communication method includes transmitting, by a communication device, a power headroom report (PHR) for sounding reference signal (SRS) in response to any one or more of: an uplink shared channel is configured on a carrier frequency of a serving cell, a mode being enabled, the SRS with a separate closed loop being configured, and/or a field in a medium access control-control element (MAC-CE) received by the communication device is associated with the PHR and is set to a specific value.

In some embodiments, the method further comprises any one or more of: the mode indicates that a single downlink beam state and one or more uplink beam states are indicated is enabled; the mode indicates that a PHR for SRS is reported is enabled; the mode is configured per serving cell or per bandwidth part (BWP); the SRS is associated with antenna switching or a downlink (DL) channel state information (CSI) acquisition; or the SRS is configured with a flag. In some embodiments, the flag is configured per SRS resource or per SRS resource set. In some embodiments, whether the PHR for the SRS is based on a transmission or a reference format is determined according to a time unit of a SRS transmission or a downlink control information (DCI) triggering the SRS, and/or a time unit of the PHR. In some embodiments, for periodic SRS or semi-persistent SRS, whether the PHR for SRS is based on a transmission or a reference format is determined according to a time unit of SRS transmission. In some embodiments, for aperiodic SRS, whether the PHR for SRS is based on a transmission or a reference format is determined according to a time unit of a downlink control information (DCI) triggering the SRS.

In some embodiments, in response to a time unit of the SRS being associated with or being overlapped with a same time unit as that of the PHR, the PHR for the SRS is based on a transmission. In some embodiments, the PHR is determined according to a first SRS transmission occasion in the time unit. In some embodiments, the method further comprises any one or more of: the time unit of the SRS comprises a slot of the SRS, or a time domain window corresponding to the SRS; or the time unit of the PHR comprises a slot of the PHR, or a time domain window corresponding to the PHR. In some embodiments, the time domain window comprises a time duration from X time unit before SRS or PHR to Y time units after the SRS or PHR, where X and Y are integers.

In some embodiments, X is the same value as Y, or X or Y is up to a capability signaling. In some embodiments, in response to a time unit of the PHR associating with or overlapping with multiple time units corresponding to one or more SRSs, the PHR is based on a SRS transmission occasion in a first time unit in order from the multiple time units. In some embodiments, in a medium access control-control element (MAC-CE) signaling or a radio resource control (RRC) signaling that carries the PHR for the SRS, any one or more of a configured maximum transmission power, maximum power reduction (MPR), or a maximum permissible exposure (MPE) is provided.

A third example wireless communication method includes transmitting, by a network device, one or more beam states, where at least one beam state of the one or more beam states is associated with a channel or a reference signal; and communicating, by the network device, the channel or the reference signal according to the at least one beam state.

In some embodiments, the reference signal comprises a sounding reference signal (SRS) associated with a separate closed loop in a component carrier, and the method further comprises: transmitting, by the network device, a control information, the control information includes a transmission power command (TPC) for the SRS, the transmission power of the SRS in the component carrier is determined according to the TPC. In some embodiments, the at least one beam state is associated with a timing advance group (TAG) index and/or a power control parameter, a communication of the channel or the reference signal in the component carrier is determined according to the TAG index or the power control parameter.

A fourth example wireless communication method includes receiving, by a network device, a power headroom report (PHR) for sounding reference signal (SRS) in response to any one or more of: an uplink shared channel is configured on a carrier frequency of a serving cell, a mode being enabled, the SRS with a separate closed loop being configured, and/or a field in a medium access control-control element (MAC-CE) transmitted by the network device is associated with the PHR and is set to a specific value.

In some embodiments, the method further comprises any one or more of: the mode indicates that a single downlink beam state and one or more uplink beam states are indicated is enabled; the mode indicates that a PHR for SRS is reported is enabled; the mode is configured per serving cell or per bandwidth part (BWP); the SRS is associated with antenna switching or a downlink (DL) channel state information (CSI) acquisition; or the SRS is configured with a flag.

In some embodiments, one of the one or more beam states is associated with a quasi-colocation (QCL) for a downlink channel or a downlink reference signal, a spatial filter for an uplink channel or an uplink reference signal, or a power control information for an uplink channel or an uplink reference signal. In some embodiments, the control information format includes a downlink control information (DCI) format.

In yet another exemplary aspect, the above-described methods are embodied in the form of processor-executable code and stored in a non-transitory computer-readable storage medium. The code included in the computer readable storage medium when executed by a processor, causes the processor to implement the methods described in this patent document.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIG. 1 shows an example beam based UL/DL transmission, where the full line represents the selected transmit (Tx)/receive (Rx) beam for transmission.

FIG. 2 shows an example of an asymmetric DL-single-TRP (DL-STRP) and UL-multi-TRP (UL-mTRP).

FIG. 3 shows an example diagram of DL/UL site decoupling in an example heterogeneous network (HetNet).

FIGS. 4A-4D show example cases for beam state indication in DL sTRP and UL mTRP.

FIG. 5 shows an exemplary block diagram of a hardware platform that may be a part of a network device or a communication device.

FIG. 6 shows an example of wireless communication including a base station (BS) and user equipment (UE) based on some implementations of the disclosed technology.

FIG. 7 shows an exemplary flowchart for communicating according to a beam state.

FIG. 8 shows an exemplary flowchart for transmitting a power headroom report (PHR) for sounding reference signal (SRS).

FIG. 9 shows another exemplary flowchart for communicating according to a beam state.

FIG. 10 shows an exemplary flowchart for receiving a PHR for a SRS.

### DETAILED DESCRIPTION

5G NR and also LTE has a basic assumption of downlink-uplink (DL-UL) collocation for radio architecture, that is, the assumption is that downlink (DL) transmission point (TRP) should have the same location of UL-TRP. In such an architecture, DL and UL operation can be unified, where the operations involve beam management, radio resource management (RRM), TRP selection and handover (HO). The TRP/beam selection and subsequent HO are performed based on the DL measurement/report, and then the selected TRP/beam information (i.e., the corresponding DL RS(s)) is applied to both DL and UL. However, with the development of 5G NR, the assumption of DL-UL collocation is becoming an obstacle to the further evolution or improvement of UL transmission as further explained below.
Firstly, deploying new UL-TRP(s) (with low-cost due to saving DL Tx circuits, e.g., power amplitude (PA)) in current network (NW) for balancing coverage/throughput between DL and UL has become an emerging technique. That implies that an improved architecture of DL-UL-non-collocation (site-decoupling) may be needed.
Secondly, heterogeneous network (HetNet) is another scenario of asymmetric DL sTRP and UL mTRP through identifying optimal UL-serving TRP(s) from existing marco/micro BSs (i.e., DL/UL-site-decoupling), rather than mitigating inter-cell interference by reducing DL Tx power from macro BS.
Thirdly, NW energy saving via powering off DL links of the portion of TRP(s), and then, in order to achieve this target, DL-UL-non-collocation (site-decoupling) may be considered.

In order to achieve asymmetric DL-single-TRP (DL-STRP) and UL-multi-TRP (UL-mTRP) architecture, assuming intra-band intra-cell non-co-located mTRP scenarios, the following may be considered: enhancement on UL beam state/power control (PC) parameter indication, separate power control (PC) procedure for SRS to DL sTRP from other SRS to UL TRP(s), and/or pathloss measurement for UL channel/RS to UL mTRP (if DL-RS from UL mTRP is absent). For example:

In order enabling UL-mTRP operation independent from DL-sTRP, the procedure of the UL beam state and PC parameter indication may be considered. For UL beam state, indication of two or more UL beam state(s) corresponding to respective UL channel/RS may be considered, but there may be only one DL beam state for DL channel/RS reception. Then, besides for UL spatial domain filtering information, the beam state also needs to provide UL PC parameter, e.g., pathloss (PL) value determination (if no DL-RS configuration), or P0/alphas/closed loop parameters.

Then, for separate power control (PC) procedure for SRS to DL sTRP from other SRS to UL TRP(s), independent UL power control procedure may be provided, where the UL power control procedure involve separate UL power control closed loop, transmission power command (TPC), and power headroom report (PHR) corresponding to SRS. For PHR, there may be a need to have the PHR for SRS reported along with other PHR report, e.g., PUSCH-PHR in the same component carrier (CC).

Finally, regarding pathloss measurement for UL channel/RS to UL mTRP, if DL-RS from UL mTRP is absent, the NW should perform the corresponding measurement results for UL-PL (e.g., based on SRS to UL mTRP) and provide the corresponding PL value (e.g., PL offset corresponding to other UL channel(s)/RS(s)). While measuring absolute PL value, TX power related parameter (e.g., energy per resource element (EPRE)) of UL channel/RS can be reported to gNB.

At the expense of wide or ultra-wide spectrum resources, the considerable propagation loss induced by the extremely high frequency becomes a noticeable challenge. To solve this, antenna array and beam-forming training technologies using massive MIMO, e.g., up to 1024 antenna elements for one node, have been adopted to achieve beam alignment and obtain sufficiently high antenna gain. To keep low implementation cost while still benefitting from antenna array, analog phase shifters can be attractive for implementing mmWave beam-forming, which means that the number of controllable phases is finite and the constant modulus constraints are placed on these antenna elements. Given the pre-specified beam patterns, the variable-phase-shift-based BF training targets to identify the best pattern for subsequent data transmission generally, in the one-TRP and one-panel case.

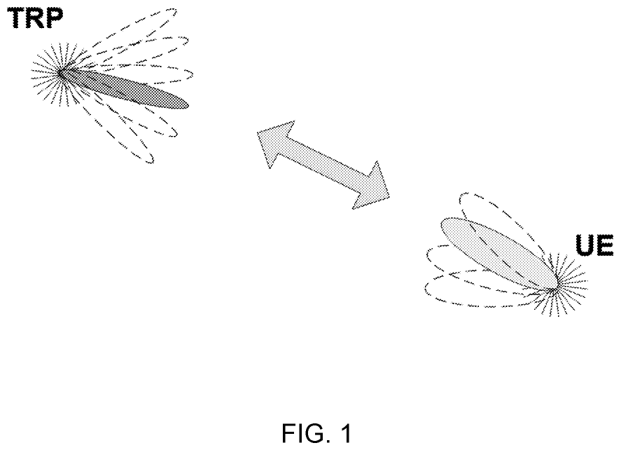

FIG. 1 shows an example beam based UL/DL transmission, where the full line represents the selected Tx/Rx beam for transmission.

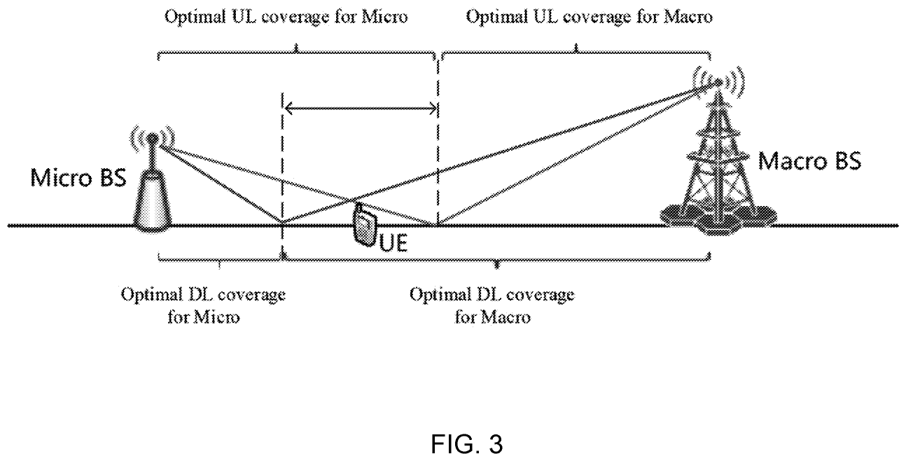

In the asymmetric DL-single-TRP (DL-STRP) and UL-multi-TRP (UL-mTRP) scenario (involving DL/UL-site decoupling in HetNet), we have the following two schemes for UL transmission:
Scheme-1: Dynamic Uplink-Point Selection (DuPS). For instance, best uplink-point from macro BS and UL-only TRPs is selected with objective of maximizing UL-throughput and UL-RSRP (as shown for UE-2). Then, it is similar to the case of DL/UL-site decoupling in HetNet as shown in FIG. 3, where the UL site is independently selected from all candidate macro/micro BSs instead of being always aligned with the DL-serving BS.
Scheme-2: Joint Reception across Multiple Points (JRxMP). In such case, UL-TRPs (e.g., UL-only TRPs) are regarded as additional distributed antenna(s) for BS, and then coherent joint reception is preformed (as shown for UE-1).

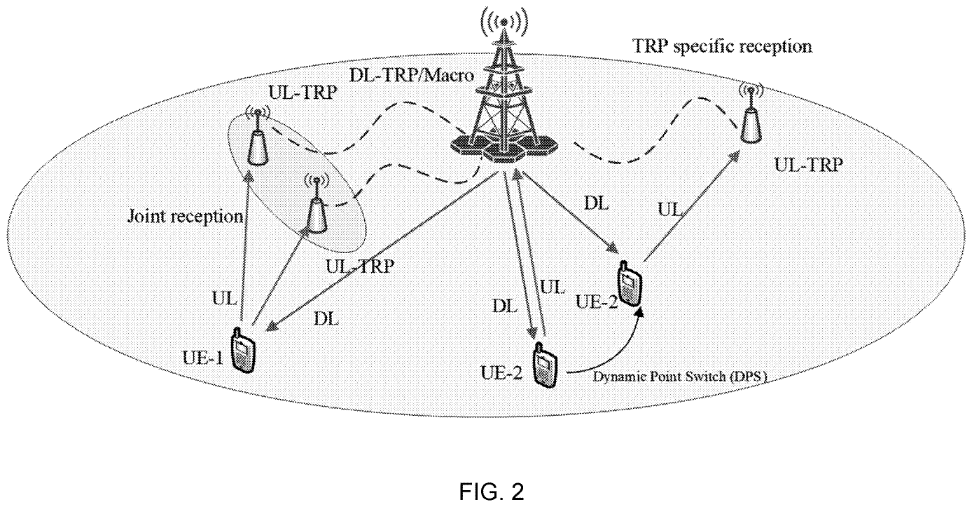

FIG. 2 shows an example of an asymmetric DL-single-TRP (DL-STRP) and UL-multi-TRP (UL-mTRP).

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

### I. Embodiment #1: Beam State Indication in DL sTRP and UL mTRP

In order to enable asymmetric DL-sTRP and UL-mTRP (noted that DL-sTRP and UL-sTRP can be assumed as a specific case for that), beam state indication of one or more DL beam state, one or more UL beam state or one or more joint beam state can be provided for channel/RS transmission. Specifically, at least one of the following can be indicated by NW:
A DL beam state and a UL beam state
   Furthermore, in such case, separate TCI indication signalling for sTRP operation (a DL TCI state+a UL TCI state) can be reused herein, and then we can use individual TCI indication/activation procedure for SRS to DL-TRP.
A joint beam state and a UL beam state
   Furthermore, if a mode (e.g., for DL sTRP and UL mTRP) is enabled, a joint beam state and a UL TCI state is provided. For instance, if Pi field in a MAC-CE for TCI activation is set to 1, joint TCI state (rather than DL TCI state as in Rel-17)+the UL TCI state are provided for a codepoint.
   Furthermore, if a mode is enabled, there are two beam states, and then first beam state of the two beam states is applied to both DL and UL but second beam state of them is applied to UL.
      For DL signal, there is only one indicated beam state (i.e., joint beam state) applied (e.g., for determining QCL assumption for the corresponding DL signal transmission/reception);
      For UL signal, there are two indicated beam state (i.e., a joint beam state+a UL beam state)
   Furthermore, a joint beam state means that the joint beam state can applied to both DL and UL.
   For instance, in such case, separate TCI indication signalling for sTRP operation is enhanced to indicate both joint TCI state and another UL TCI state. That means that for DL transmission, there is a still one indicated DL TCI state applying to DL transmission, but there are two indicated UL TCI state applied to one or more UL transmission (involving two indicated UL TCI state applied to a single UL transmission or applied to two respective UL transmission).
A DL beam state+two (or up to two) UL beam states (comprising a first UL beam state and a second UL beam state)
   Furthermore, there are two indicated beam states for UL, but there is one indicated beam state for DL.
Two DL beam states+two (or up to two) UL beam states
   Furthermore, the two beam states can be the same one. That means that, from a signalling perspective, there are up to two DL beam states but which can be the same one.
Two (or up to two) joint beam states
   Furthermore, only one of two joint beam states is applied to DL, and then another joint beam states does not applied to DL.
A joint beam state+two (or up to two) UL beam states (comprising a first UL beam state and a second UL beam state).
   Furthermore, the joint beam state is applied to a specific SRS.
      Furthermore, the specific SRS is transmitted to DL TRP, e.g., for DL CSI acquisition or antenna switching (e.g., in TDD).
   Furthermore, the first and second beam state is applied to UL (rather than the specific SRS).
A DL beam state+three (or up to three) UL beam states (comprising a first UL beam state, a second UL beam state and a third beam state)
   Furthermore, the third beam state is applied to a specific SRS.
      Furthermore, the specific SRS is transmitted to DL TRP, e.g., for DL CSI acquisition or antenna switching (e.g., in TDD)
   Furthermore, the first and second beam state is applied to UL (except for the specific SRS)
Furthermore, the DL beam state can be from the one or more UL beam state.

Furthermore, the following can be an interpretation for each type of channel/RS. In the techniques described below, the terms “first” and “second” indicate a particular order.
Furthermore, PDSCH can apply the first DL beam state or the first joint beam state.
Furthermore, CORESET can apply the first DL beam state or the first joint beam state.
Furthermore, CSI-RS can apply the first DL beam state or the first joint beam state.
Furthermore, PUSCH can apply the first and/or second UL beam state, or first and/or second joint beam state.
   Furthermore, the PUSCH can apply the second joint beam state.
   Furthermore, the first joint beam state can NOT apply to PUSCH.
Furthermore, PUCCH can apply the first and/or second UL beam state, or first and/or second joint beam state.
   Furthermore, the PUSCH can apply the second joint beam state.
   Furthermore, the first joint beam state can NOT be applied to PUSCH.
Furthermore, SRS (e.g., SRS for codebook or non-codebook, or SRS except for SRS for beam management or SRS for antenna switching) can apply the first and/or second UL beam state, or first and/or second joint beam state.
Furthermore, SRS for antenna switch can (or should) apply the first UL beam state, or first joint beam state.
   Furthermore, the SRS for antenna switch can apply the first joint beam state.
   Furthermore, the second joint beam state can NOT be applied to the SRS for antenna switch.

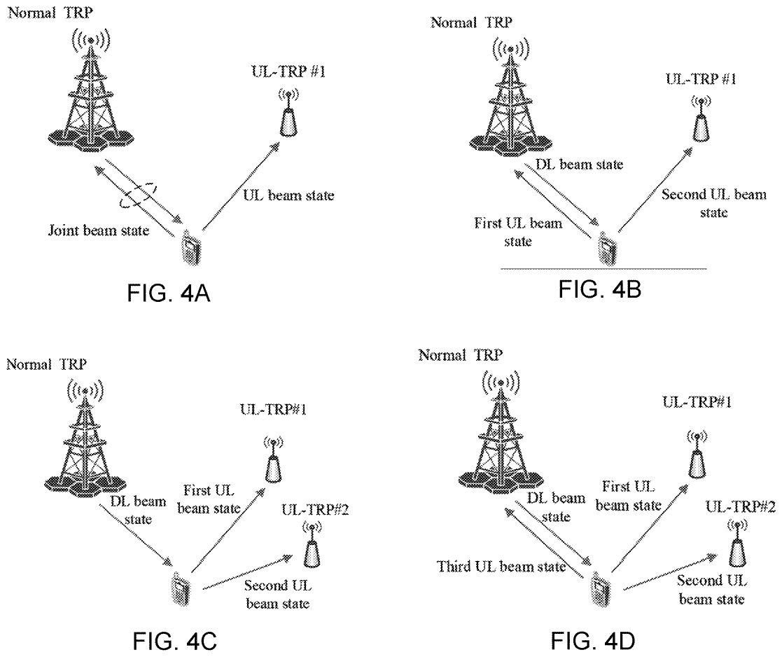

For instance, we have the following example for asymmetric DL sTRP and UL mTRP cases as shown in FIGS. 4A-4D.
For case shown in FIG. 4A, a joint beam state and a UL beam state are indicated, and then the joint beam state is applied to SRS for antenna switching for DL CSI acquisition in TDD.
For case shown in FIG. 4B, a DL beam state, a first UL beam state and a second beam state are indicated. Then the first UL beam state is applied to SRS for antenna switching, and the second UL beam state is applied to UL channel/RS other than the SRS for antenna switching.
For case shown in FIG. 4C, a DL beam state, a first UL beam state and a second beam state are indicated. But, the first and second UL beam state are applied to UL channel (e.g., for TDD repetition or UL simultaneous transmission in UL MTRP operation). Then, if having SRS for antenna switching, an individual TCI indication/activation procedure for SRS can be used for DL-TRP (i.e., normal TRP).
For case shown in FIG. 4D, a DL beam state and a first/second/third UL beam state are indicated. Then, the first and second UL beam state is applied to MTRP-based UL transmission (e.g., SDM/SFN, TDMed repetition). The third UL beam state is used for SRS transmitted to DL-TRP (i.e., normal TRP).
   Notice that the case-d can be assumed as a normal/general case for DL sTRP and UL mTRP operation.

### II. Embodiment #2: Separate Closed Loop Procedure for SRS to DL-TRP

In this embodiment, separate power control procedure for SRS to DL-TRP is described, where there is PUCCH and/or PUSCH in a UL. Then, we may have one or more separate closed-loop for the SRS, where one closed loop is used for SRS for beam management (e.g., configured grant) and then another closed loop is used for SRS to DL-TRP.
Furthermore, if a mode (e.g., for asymmetric DL sTRP and UL mTRP) is enabled, DCI format 2_3 can be used for indicating TPC for SRS in a CC
   Furthermore, the SRS has a separate closed loop.
   Furthermore, the PUSCH can be configured in the CC.
Furthermore, one field in DCI (i.e., DCI format 2_3) is to indicate the closed-loop index for the TPC command, i.e., closed loop index+TPC.
   Furthermore, the field can be 0-bit, if there is only one separate closed loop for SRS is configured
   Furthermore, if there are one or more TPC fields in only one block in the DCI, the fields of closed loop index is provided for each TPC field, respectively.
   Furthermore, if there is one or more blocks in the DCI, one of the one or more blocks in the DCI comprises a field of closed loop index and a TPC field.
Furthermore, the closed-loop index for a TPC command is determined according to the following:
   CORESET or search space set associated with the DCI.
      For instance, the closed loop index for the TPC command is determined according to the CORESET index associated with the DCI, e.g., closed loop index for the TPC is mod (CORESET index, 2).
      Closed loop index can be configured/associated with CORESET or search space set. That means that, TPC command is applied to the closed loop associated with the CORESET or search space set.
         If closed loop index is not configured with CORESET or search space set, the TPC command is associated with first closed loop for SRS, e.g., closed loop=0, or i1.
   Time unit of the DCI.
      For instance, the closed loop index for the TPC command is determined according to the time unit of the DCI.
         Furthermore, the time unit of the DCI refers to first or second half slot in a subframe.
         For instance, first half slot in a subframe is for first TPC command, and then second half slot in a subframe is for second TPC command.
         Furthermore, the time unit of the DCI refers to odd or even slot in a subframe.
         For instance, odd slot in a subframe is for first TPC command, and then even slot in a subframe is for second TPC command.
   CC/BWP associated with DCI.
      For instance, closed loop index can be configured/associated with CC or BWP. That means that, TPC command is applied to the closed loop associated with the CC or BWP carrying the DCI.
         If closed loop index is not provided, the TPC command is associated with first closed loop for SRS, e.g., closed loop=0, or i1.

Then, the separate closed loop index can be configured per SRS resource set, and then while transmitting the SRS resource set, the UE can obtain the closed loop value associated with the separate closed loop for the SRS.

It is noticed that DCI format 2_3 is used for the transmission of a group of TPC commands for SRS transmissions by one or more UEs. Along with a TPC command, a SRS request may also be transmitted. The following information is transmitted by means of the DCI format 2_3 with CRC scrambled by TPC-SRS-RNTI:
block number 1, block number 2, . . . , block number N.
   where the starting position of a block is determined provided by higher layer parameter (e.g., startingBitOfFormat2-3 or startingBitOfFormat2-3SUL-v1530) for the UE configured with the block.
For instance, for one block (i.e., N=1) is configured for UE, and if a field in DCI (i.e., DCI format 2_3) is to indicate a closed-loop index for the TPC command (i.e., srs-TPC-PDCCH-group=type-A). The block comprises at least one of:
   SRS request field, closed-loop index field #1, TPC field #1, closed-loop index field #2, TPC field #2, . . . , closed-loop index field #N, TPC field #N.
For instance, for multiple blocks (i.e., N can be greater than or equal to 1) are configured for UE, a block in DCI (i.e., DCI format 2_3) is to indicate a closed-loop index for the TPC command (i.e., srs-TPC-PDCCH-group=type-A) and a TPC field for the block. The block comprises at least one of:
   SRS request field, closed-loop index field, TPC field.

### III. Embodiment #3: Independent PHR for SRS to DL-TRP Along with PHR for PUSCH

In this embodiment, we elaborate independent PHR for SRS to DL-TRP along with PHR for PUSCH, in order to support independent power control for SRS to DL-TRP which may use different PL-RS configuration or PL estimate/assumption for the transmission to DL-TRP compared with other channels/RSs (i.e., PUSCH) to UL-TRP.

In such case, the UE can transmit a PHR for SRS (i.e., Type-3 PHR) for a serving cell when at least one of the following is satisfied:
Condition-1: UE is configured for PUSCH transmissions on carrier frequency f of the serving cell c
Condition-2: A mode (e.g., for asymmetric DL sTRP and UL mTRP) is enabled;
   Furthermore, the mode is configured per serving cell or per BWP.
Condition-3: SRS with a separate closed loop is configured.
   Furthermore, the SRS is for antenna switching or DL CSI acquisition.
   Furthermore, the SRS is configured with a flag (e.g., distinguished from other SRS, or having an individual PHR for the SRS (e.g., regardless of the corresponding serving cell configured with a PUSCH or not)).
      For instance, the flag can be configured per SRS resource or per SRS resource set.
Condition-4: A field in the MAC-CE associated with the PHR is set to a specific value, e.g., if the field is set to 1, the PHR for SRS can be reported in the MAC-CE; otherwise, the corresponding field for the PHR for SRS is reserved or omitted.

Furthermore, the PHR for SRS is based on a real transmission or a reference format determined according to the time unit of SRS transmission or DCI triggering the SRS, and/or a time unit of PHR report (which refer to a PUSCH carrying the PHR).
Furthermore, for periodic/semi-persistent SRS, the PHR for SRS is based on a real transmission or a reference format determined according to the time unit of SRS transmission;
Furthermore, for aperiodic SRS, the PHR for SRS is based on a real transmission or a reference format determined according to the time unit of DCI triggering the SRS.
Furthermore, if a time unit of SRS is associated with/overlapped with the same time unit of the PHR report, the PHR for SRS is based on a real transmission.
   For instance, if SRS is associated with the same slot of the PHR report, the PHR for SRS is based on a real transmission.
   Furthermore, the PHR is determined according to first SRS transmission occasion in the time unit.
   Furthermore, the time unit of SRS comprises a slot of SRS, or a time domain window corresponding to SRS.
      Furthermore, the time domain window comprises a time duration from X time unit before the slot of the SRS to Y time units after the slot of the SRS, where X and Y is an integer (e.g., 0, 1, 2, 3, 4, or 14).
         For instance, the time domain window comprises a time duration from 1 slot/14 symbols before the slot of the SRS to 1 slot/14 symbols after the slot of the SRS
         For instance, the time domain window comprises a time duration from the slot of the SRS to 1 slot/14 symbols after the slot of the SRS (i.e., X=0, and Y=1 slot/14 symbols).
         Furthermore, X and Y can be the same value or up to UE capability signaling.
   Furthermore, the time unit of PHR report comprises a slot of PHR report, or a time domain window corresponding to PHR report.
      Furthermore, the time domain window comprises a time duration from X time unit before the slot of the PHR report to Y time units after the slot of the PHR report, where X and Y is an integer (e.g., 0, 1, 2, 3, 4, or 14).
         For instance, the time domain window comprises a time duration from 1 slot/14 symbols before the slot of the PHR to the slot of the PHR (i.e., X=1 slot/14 symbols, Y=0)
         Furthermore, X and Y can be the same value or up to UE capability signaling.
   Furthermore, if a time unit of the PHR report overlap with multiple time units corresponding to SRS, the PHR for SRS is based on a SRS transmission occasion in a first time unit of the multiple time units.
      For instance, in CA case, if a SCS configuration μ_1 on active UL BWP b_1 of carrier f_1 of serving cell c_1 is smaller than a SCS configuration μ_2 on active UL BWP b_2 of carrier f_2 of serving cell c_2, and if the UE provides a PHR report in a PUSCH transmission in a slot on active UL BWP b_1 that overlaps with multiple slots on active UL BWP b_2, the UE provides a PHR report for the SRS, if any, on the first slot of the multiple slots on active UL BWP b_2 that fully overlaps with the slot on active UL BWP b_1.
   Furthermore, if a time unit of the PHR report overlap with multiple time units of SRS, the PHR for SRS is based on a first SRS transmission occasion in a time unit of the multiple time units.

Furthermore, in the MAC-CE or in a RRC signaling carrying the PHR for SRS, at least one of configured maximum transmission power (Pc,max), maximum power reduction (P-MPR) and/or maximum permissible exposure (MPE) can be provided in order to indicating the maximum Tx power for the SRS transmission.
Furthermore, the PHR for SRS can be a real PHR in such case.

### IV. Embodiment #4: PL and Beam State Indication for UL Signal to UL-TRP

In this embodiment, PL measurement for UL channel/RS is transmitted to UL-TRP, where the DL RS used for PL estimate may be absent or not provided.

Furthermore, a beam state can be associated with a TAG index, and/or a power control parameter. The UE can receive the beam state that can be associated with the TAG index and/or the power control parameter(s), and the UE can transmit uplink channel/RS based on the TAG information and/or the power control parameter(s) (e.g., Tx power offset or pathloss).
Furthermore, a beam state can be associated with a power offset or a pathloss value by RRC or MAC-CE.
   Furthermore, a power offset comprises a power offset value or a power offset index
      Furthermore, the power offset value can be configured/updated by RRC or MAC-CE.
      Furthermore, the power offset index is associated with a power offset value and then is associated with the beam state.
Furthermore, the transmission power for a UL signal is determined to according to a pathloss estimate of a PL-RS associated with beam state and the power offset.
   Furthermore, the pathloss estimate corresponding to the beam state is determined according to a pathloss estimate of a PL-RS associated with beam state plus the power offset value.
Furthermore, when a beam state is associated with a pathloss value, the PL-RS associated with the beam state can be absent, ignored or precluded.

Then, PL value can be measured by SRS and then individually configured by gNB, and then Tx power of SRS can be signaled by UE to gNB by MAC-CE or RRC.

In this patent document, the term “beam state” can be equivalent to quasi-co-location (QCL) state, transmission configuration indicator (TCI) state, spatial relation (also called as spatial relation information), reference signal (RS), spatial filter or pre-coding. Furthermore, in this patent document, “beam state” is also called as “beam” or “TCI state”.

Furthermore, in this patent document, ‘beam state’ can be equivalent to ‘indicated beam state’ or ‘indicated TCI state’.

Furthermore, in this patent document, ‘DL beam state’ comprises ‘joint/DL TCI state’, ‘joint TCI state’, ‘DL TCI state’ or ‘TCI state’. Furthermore, in this patent document, ‘DL beam state’ is applied to DL signal.

Furthermore, ‘DL beam state’ can be equivalent to ‘beam state’. Furthermore, ‘DL TCI state’ can be equivalent to ‘TCI state’.

Furthermore, in this patent document, ‘UL beam state’ comprises ‘joint/UL TCI state’, ‘joint TCI state’ or ‘UL TCI state’. Furthermore, in this patent document, ‘UL beam state’ is applied to UL signal.

Furthermore, ‘UL beam state’ can be equivalent to ‘UL TCI state’.

Furthermore, in this patent document, ‘a joint beam state’ can apply to both DL and UL signal.

The term “Tx beam” can be equivalent to QCL state, TCI state, spatial relation state, DL reference signal, UL reference signal, Tx spatial filter or Tx precoding;

The term “Rx beam” can be equivalent to QCL state, TCI state, spatial relation state, spatial filter, Rx spatial filter or Rx precoding;

The term “beam ID” can be equivalent to QCL state index, TCI state index, spatial relation state index, reference signal index, spatial filter index or precoding index.

Specifically, the spatial filter can be either UE-side or gNB-side one, and the spatial filter is also called as spatial-domain filter.

In this patent document, “spatial relation information” can be comprised of one or more reference RSs, which is used to represent the same or quasi-co “spatial relation” between targeted “RS or channel” and the one or more reference RSs.

In this patent document, “spatial relation” can mean the beam, spatial parameter, or spatial domain filter.

In this patent document, “beam state” can be comprised of one or more reference RSs and/or their corresponding QCL type parameters, where QCL type parameters include at least one of the following aspect or combination: [1] Doppler spread, [2] Doppler shift, [3] delay spread, [4] average delay, [5] average gain, and [6] Spatial parameter (which is also called as spatial Rx parameter). In this patent document, “beam state” can be equivalent to “QCL state” or “TCI state”. In this patent document, ‘QCL-TypeA’, ‘QCL-TypeB’, ‘QCL-TypeC’, and ‘QCL-TypeD’ can be described to include the following:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

In this patent document, a RS comprises channel state information reference signal (CSI-RS), synchronization signal block (SSB) (which is also called as SS/PBCH), demodulation reference signal (DMRS), sounding reference signal (SRS), and physical random access channel (PRACH). Furthermore, the RS at least comprises DL reference signal and UL reference signalling.

A DL RS at least comprises CSI-RS, SSB, DMRS (e.g., DL DMRS);

A UL RS at least comprises SRS, DMRS (e.g., UL DMRS), and PRACH.

In this patent document, “UL signal” can be PUCCH, PUSCH, or SRS.

In this patent document, “DL signal” can be PDCCH, PDSCH, or CSI-RS.

In this patent document, “time unit” can be sub-symbol, symbol, slot, subframe, frame, or transmission occasion.

In this patent document, CSI-RS for CSI can be equivalent to CSI-RS configured without the higher layer parameters repetition and trs-Info.

In this patent document, CSI-RS for tracking can be equivalent to CSI-RS configured with higher layer parameter trs-Info.

In this patent document, CSI-RS for beam management can be equivalent to CSI-RS configured with higher layer parameter repetition.

In this patent document, power control parameter comprises at least one of pathloss RS, open-loop parameter, and closed loop index. In this patent document, ‘power control parameter’ can be equivalent to ‘UL power control parameter’. In this patent document, ‘not being associated with a separate closed loop’ can be equivalent to ‘being associated with a closed loop as PUSCH’.

In this patent document, ‘closed loop index’ can be equivalent to ‘power control adjustment state’.

In this patent document, ‘open-loop parameter’ comprises at least one of a target power, i.e., P0, and a factor, i.e., alpha.

In this patent document, ‘a mode’ comprises that ‘a PHR for SRS is enabled’ (e.g., regardless of a PUSCH configuration in the corresponding carrier component/cell), ‘a single downlink beam state and one or more uplink beam states are indicated’, or ‘a downlink signal to a communication device and one or more uplink signals to one or more network devices’ or ‘a single downlink TRP and multiple uplink TRPs’.

In this patent document, ‘control information’ may comprise ‘a control information format.’ In this patent document, ‘control information format’ may include ‘a downlink control information (DCI) format.’ In this patent document, ‘a carrier component’ may comprise ‘a cell’.

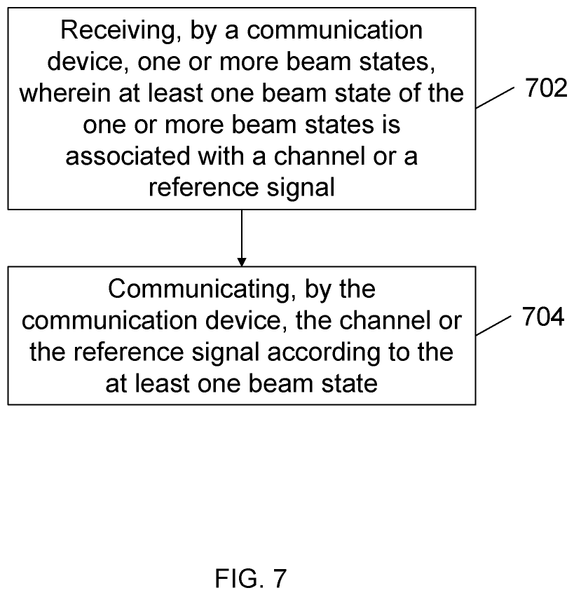

FIG. 7 shows an exemplary flowchart for communicating according to a beam state. Operation 702 includes receiving, by a communication device, one or more beam states, where at least one beam state of the one or more beam states is associated with a channel or a reference signal. Operation 704 includes communicating, by the communication device, the channel or the reference signal according to the at least one beam state.

In some embodiments, the one or more beam states comprise any one or more of: a downlink beam state and an uplink beam state, a joint beam state and one or more uplink beam states, a downlink beam state and one or more uplink beam states, one or more downlink beam states and one or more uplink beam states, or one or more joint beam states. In some embodiments, the method comprises at least one of: the communication device receives a radio resource control (RRC) parameter associated with a mode; the joint beam state is applied to both downlink and uplink; the downlink beam state is applied to downlink; or the uplink beam state is applied to uplink. In some embodiments, the one or more beam states comprises two or more downlink beam states or two or more joint beam states, and the method further comprises any one or more of: the two or more downlink beam states or the two or more joint beam states belong to a same beam state or a same quasi colocation (QCL) property; a first downlink beam state of the two or more downlink beam states or a first joint beam state of the two or more joint beam states is applied to downlink; or one or more second downlink beam states of the two or more downlink beam states or one or more second joint beam states of the two or more joint beam states are ignored or not applied to downlink.

In some embodiments, the at least one beam state from the one or more beam states comprises a joint beam state or an uplink beam state, and the reference signal comprises a sounding reference signal (SRS). In some embodiments, the SRS is used for antenna switching, the SRS is used for channel-state-information (CSI) acquisition, or the SRS is associated with a separate closed loop. In some embodiments, the at least one beam state from the one or more beam states comprises a joint beam state or an uplink beam state, and the reference signal comprises a sounding reference signal (SRS) that is not used for antenna switching, is not used for channel-state-information (CSI) acquisition, or is not associated with a separate closed loop. In some embodiments, the method further comprises any one or more of: the channel comprises a physical downlink shared channel (PDSCH) applying a first downlink beam state or a first joint beam state; the channel comprises a control resource set (CORESET) applying a first downlink beam state or a first joint beam state; the reference signal comprises a channel state information reference signal (CSI-RS) applying a first downlink beam state or a first joint beam state; the channel comprises a physical uplink shared channel (PUSCH) applying a first uplink beam state and/or a second uplink beam state, or a first joint beam state and/or a second joint beam state; the channel comprises a physical uplink control channel (PUCCH) applying a first uplink beam state and/or a second uplink beam state, or a first joint beam state and/or a second joint beam state; or the reference signal comprises a sounding reference signal (SRS) applying a first uplink beam state and/or a second uplink beam state, or a first joint beam state and/or a second joint beam state.

In some embodiments, the first downlink beam state or the first joint beam state is associated with a first flag or a first index in the one or more beam states; the first uplink beam state or the first joint beam state is associated with a first flag or a first index in the one or more beam states; or the second uplink beam state or the second joint beam state is associated with a second flag or a second index in the one or more beam states. In some embodiments, a first joint beam state is not allowed to be applied to a physical uplink shared channel (PUSCH); a first joint beam state is not allowed to be applied to a physical uplink control channel (PUCCH); or a second joint beam state is not allowed to be applied to a sounding reference signal (SRS) for antenna switching or DL CSI acquisition. In some embodiments, the reference signal comprises a sounding reference signal (SRS) associated with a separate closed loop in a component carrier, and the method further comprises: receiving, by the communication device, a control information, the control information includes a transmission power command (TPC) for the SRS, the transmission power of the SRS in the component carrier is determined according to the TPC.

In some embodiments, the method further comprises any one or more of: a mode indicating that a single downlink beam state and one or more uplink beam states are indicated is enabled; an index of the separate closed loop is configured per SRS resource set; or the SRS is associated with the separate closed loop that is separated from that of a physical uplink shared channel (PUSCH). In some embodiments, a physical uplink shared channel (PUSCH) is configured in the component carrier. In some embodiments, the SRS is associated with different beam state or different beam states from that of PUSCH.

In some embodiments, one field in the control information indicates a closed-loop index for the TPC. In some embodiments, the method further comprises any one or more of: the field comprises zero bit in response to only one separate closed loop for the SRS being configured; the control information indicates a list of closed loop index for respective closed loops; the control information indicates a list of blocks, each of block comprising a closed loop index and a TPC; or there are one or more TPC fields in the control information, and the closed loop index is applied for the one or more TPC fields. In some embodiments, a closed loop associated with the TPC is determined according to at least one of the following: a control resource set (CORESET) or a search space set associated with the control information, a time unit of the control information, or a cell, a carrier component, or a bandwidth part (BWP) associated with the control information. In some embodiments, the closed loop associated with the TPC is determined according to whether the control information is in a first time unit or a second time unit; or the closed loop associated with the TPC is determined according to whether the control information is in an odd time unit or an even time unit.

In some embodiments, the method further comprises associating, by the communication device, the at least one beam state with a timing advance group (TAG) index and/or a power control parameter, a communication of the channel or the reference signal in the component carrier is determined according to the TAG index or the power control parameter. In some embodiments, the power control parameter includes a power offset or a pathloss value; or the at least one beam state is associated with the power offset or the pathloss value by a radio resource control (RRC) or a medium access control-control element (MAC-CE). In some embodiments, the power offset comprises a power offset value or a power offset index. In some embodiments, the power control parameter includes a power offset, and a transmission power with which the communication is performed is according to a pathloss estimate of a pathloss reference signal (PL-RS) associated with the at least one beam state and the power offset.

In some embodiments, the power control parameter includes a pathloss value, and further comprising any one or more of: the at least one beam state is not associated with a pathloss reference signal (PL-RS); or the PL-RS associated with the at least one beam state is absent, ignored or precluded. In some embodiments, the method further comprises transmitting, by the communication device, a signaling carrying an information related to a sounding reference signal (SRS) transmission power, the signaling comprising a radio resource control (RRC) or medium access control-control element (MAC-CE).

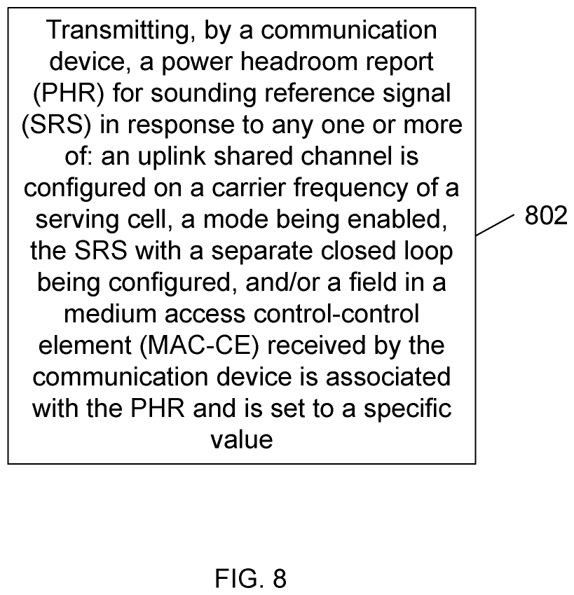

FIG. 8 shows an exemplary flowchart for transmitting a power headroom report (PHR) for sounding reference signal (SRS). Operation 802 includes transmitting, by a communication device, a power headroom report (PHR) for sounding reference signal (SRS) in response to any one or more of: an uplink shared channel is configured on a carrier frequency of a serving cell, a mode being enabled, the SRS with a separate closed loop being configured, and/or a field in a medium access control-control element (MAC-CE) received by the communication device is associated with the PHR and is set to a specific value.

In some embodiments, the method further comprises any one or more of: the mode indicates that a single downlink beam state and one or more uplink beam states are indicated is enabled; the mode indicates that a PHR for SRS is reported is enabled; the mode is configured per serving cell or per bandwidth part (BWP); the SRS is associated with antenna switching or a downlink (DL) channel state information (CSI) acquisition; or the SRS is configured with a flag. In some embodiments, the flag is configured per SRS resource or per SRS resource set. In some embodiments, whether the PHR for the SRS is based on a transmission or a reference format is determined according to a time unit of a SRS transmission or a downlink control information (DCI) triggering the SRS, and/or a time unit of the PHR. In some embodiments, for periodic SRS or semi-persistent SRS, whether the PHR for SRS is based on a transmission or a reference format is determined according to a time unit of SRS transmission. In some embodiments, for aperiodic SRS, whether the PHR for SRS is based on a transmission or a reference format is determined according to a time unit of a downlink control information (DCI) triggering the SRS.

In some embodiments, in response to a time unit of the SRS being associated with or being overlapped with a same time unit as that of the PHR, the PHR for the SRS is based on a transmission. In some embodiments, the PHR is determined according to a first SRS transmission occasion in the time unit. In some embodiments, the method further comprises any one or more of: the time unit of the SRS comprises a slot of the SRS, or a time domain window corresponding to the SRS; or the time unit of the PHR comprises a slot of the PHR, or a time domain window corresponding to the PHR. In some embodiments, the time domain window comprises a time duration from X time unit before SRS or PHR to Y time units after the SRS or PHR, where X and Y are integers.

In some embodiments, X is the same value as Y, or X or Y is up to a capability signaling. In some embodiments, in response to a time unit of the PHR associating with or overlapping with multiple time units corresponding to one or more SRSs, the PHR is based on a SRS transmission occasion in a first time unit in order from the multiple time units. In some embodiments, in a medium access control-control element (MAC-CE) signaling or a radio resource control (RRC) signaling that carries the PHR for the SRS, any one or more of a configured maximum transmission power (Pc,max), maximum power reduction (MPR), or a maximum permissible exposure (MPE) is provided.

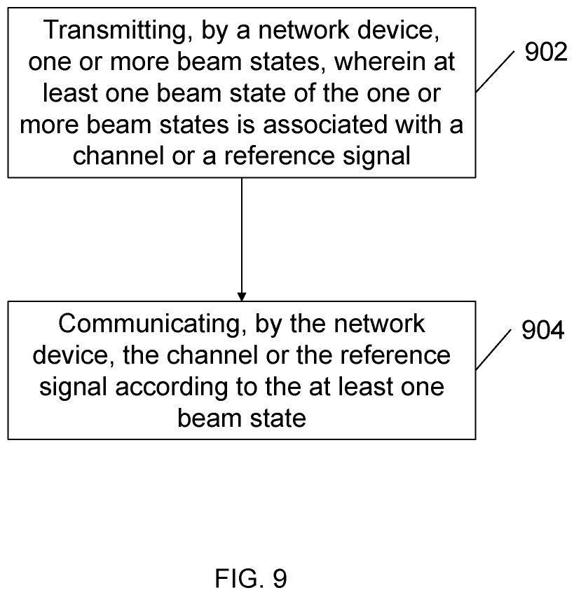

FIG. 9 shows another exemplary flowchart for communicating according to a beam state. Operation 902 includes transmitting, by a network device, one or more beam states, where at least one beam state of the one or more beam states is associated with a channel or a reference signal. Operation 904 includes communicating, by the network device, the channel or the reference signal according to the at least one beam state.

In some embodiments, the reference signal comprises a sounding reference signal (SRS) associated with a separate closed loop in a component carrier, and the method further comprises: transmitting, by the network device, a control information, the control information includes a transmission power command (TPC) for the SRS, the transmission power of the SRS in the component carrier is determined according to the TPC. In some embodiments, the at least one beam state is associated with a timing advance group (TAG) index and/or a power control parameter, a communication of the channel or the reference signal in the component carrier is determined according to the TAG index or the power control parameter.

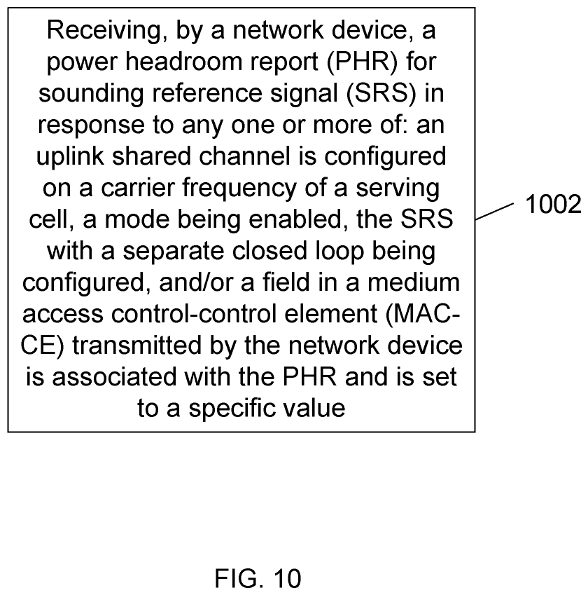

FIG. 10 shows an exemplary flowchart for receiving a PHR for a SRS. Operation 1010 includes receiving, by a network device, a power headroom report (PHR) for sounding reference signal (SRS) in response to any one or more of: an uplink shared channel is configured on a carrier frequency of a serving cell, a mode being enabled, the SRS with a separate closed loop being configured, and/or a field in a medium access control-control element (MAC-CE) transmitted by the network device is associated with the PHR and is set to a specific value.

In some embodiments, the method further comprises any one or more of: the mode indicates that a single downlink beam state and one or more uplink beam states are indicated is enabled; the mode indicates that a PHR for SRS is reported is enabled; the mode is configured per serving cell or per bandwidth part (BWP); the SRS is associated with antenna switching or a downlink (DL) channel state information (CSI) acquisition; or the SRS is configured with a flag.

In some embodiments, one of the one or more beam states is associated with a quasi-colocation (QCL) for a downlink channel or a downlink reference signal, a spatial filter for an uplink channel or an uplink reference signal, or a power control information for an uplink channel or an uplink reference signal. In some embodiments, the control information format includes a downlink control information (DCI) format.

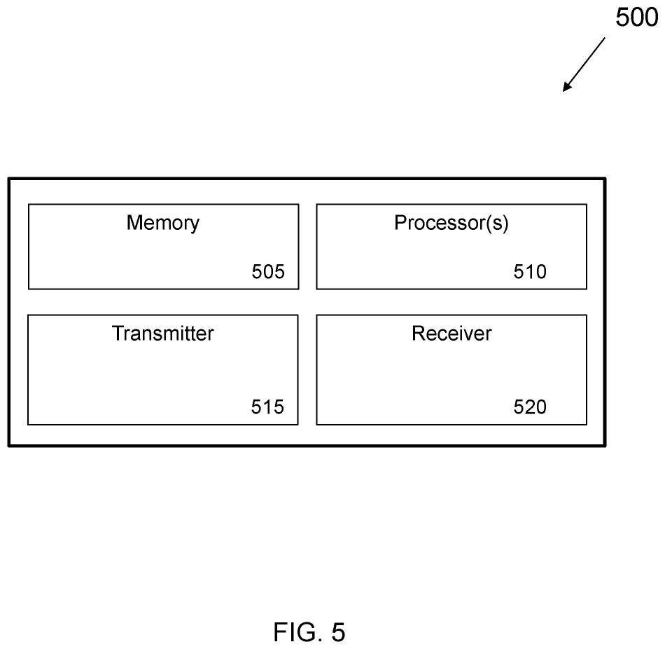

FIG. 5 shows an exemplary block diagram of a hardware platform 500 that may be a part of a network device (e.g., base station) or a communication device (e.g., a user equipment (UE)). The hardware platform 500 includes at least one processor 510 and a memory 505 having instructions stored thereupon. The instructions upon execution by the processor 510 configure the hardware platform 500 to perform the operations described in FIGS. 1 to 4C and 6 to 10 and in the various embodiments described in this patent document. The transmitter 515 transmits or sends information or data to another device. For example, a network device transmitter can send a message to a user equipment. The receiver 520 receives information or data transmitted or sent by another device. For example, a user equipment can receive a message from a network device.

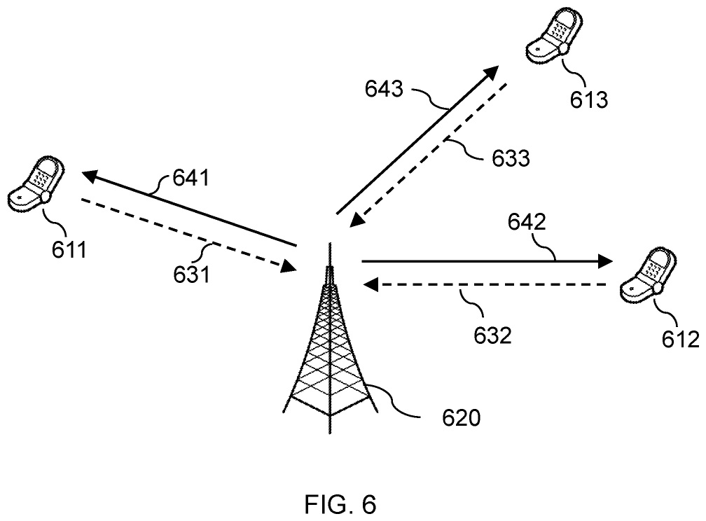

The implementations as discussed above will apply to a wireless communication. FIG. 6 shows an example of a wireless communication system (e.g., a 5G or NR cellular network) that includes a base station 620 and one or more user equipment (UE) 611, 612 and 613. In some embodiments, the UEs access the BS (e.g., the network) using a communication link to the network (sometimes called uplink direction, as depicted by dashed arrows 631, 632, 633), which then enables subsequent communication (e.g., shown in the direction from the network to the UEs, sometimes called downlink direction, shown by arrows 641, 642, 643) from the BS to the UEs. In some embodiments, the BS send information to the UEs (sometimes called downlink direction, as depicted by arrows 641, 642, 643), which then enables subsequent communication (e.g., shown in the direction from the UEs to the BS, sometimes called uplink direction, shown by dashed arrows 631, 632, 633) from the UEs to the BS. The UE may be, for example, a smartphone, a tablet, a mobile computer, a machine to machine (M2M) device, an Internet of Things (IoT) device, and so on.

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A wireless communication method, comprising:
receiving, by a communication device, one or more beam states, wherein at least one beam state of the one or more beam states is associated with a channel or a reference signal; and
communicating, by the communication device, the channel or the reference signal according to the at least one beam state.

2. The method of claim 1, wherein the one or more beam states comprises two or more downlink beam states or two or more joint beam states, and:
wherein the two or more downlink beam states or the two or more joint beam states belong to a same beam state or a same quasi colocation (QCL) property,
wherein a first downlink beam state of the two or more downlink beam states or a first joint beam state of the two or more joint beam states is applied to downlink, or
wherein one or more second downlink beam states of the two or more downlink beam states or one or more second joint beam states of the two or more joint beam states are ignored or not applied to downlink.

3. The method of claim 1,
wherein the at least one beam state from the one or more beam states comprises a joint beam state or an uplink beam state, and
wherein the reference signal comprises a sounding reference signal (SRS).

4. The method of claim 3, wherein the SRS is associated with a separate closed loop.

5. The method of claim 1,
wherein the reference signal comprises a sounding reference signal (SRS) associated with a separate closed loop in a component carrier, and
wherein the method further comprises:
receiving, by the communication device, a control information, wherein the control information includes a transmission power command (TPC) for the SRS, wherein the transmission power of the SRS in the component carrier is determined according to the TPC.

6. The method of claim 5,
wherein a mode indicating that a single downlink beam state and one or more uplink beam states are indicated is enabled,
wherein an index of the separate closed loop is configured per SRS resource set, or
wherein the SRS is associated with the separate closed loop that is separated from that of a physical uplink shared channel (PUSCH).

7. The method of claim 5, wherein a physical uplink shared channel (PUSCH) is configured in the component carrier.

8. The method of claim 5, wherein one field in the control information indicates a closed-loop index for the TPC.

9. The method of claim 8,
wherein the control information indicates a list of closed loop index for respective closed loops, or
wherein the control information indicates a list of blocks, each block comprising a closed loop index and a TPC.

10. The method of claim 5, further comprising:
associating, by the communication device, the at least one beam state with a timing advance group (TAG) index or a power control parameter,
wherein a communication of the channel or the reference signal in the component carrier is determined according to the TAG index or the power control parameter.

11. The method of claim 10,
wherein the power control parameter includes a power offset, or
wherein the at least one beam state is associated with the power offset by a radio resource control (RRC).

12. The method of claim 11, wherein the power offset comprises a power offset value or a power offset index.

13. The method of claim 10,
wherein the power control parameter includes a power offset, and
wherein a transmission power with which the communication is performed is according to a pathloss estimate of a pathloss reference signal (PL-RS) associated with the at least one beam state and the power offset.

14. A wireless communication method, comprising:
transmitting, by a communication device, a power headroom report (PHR) for sounding reference signal (SRS) in response to any one or more of:
an uplink shared channel is configured on a carrier frequency of a serving cell,
a mode being enabled,
the SRS with a separate closed loop being configured, or
a field in a medium access control-control element (MAC-CE) received by the communication device is associated with the PHR and is set to a specific value.

15. An apparatus for wireless communication comprising at least one processor, the processor configured to implement a method comprising:
receiving, by a communication device, one or more beam states, wherein at least one beam state of the one or more beam states is associated with a channel or a reference signal; and
communicating, by the communication device, the channel or the reference signal according to the at least one beam state.

16. The apparatus of claim 15, wherein the one or more beam states comprises two or more downlink beam states or two or more joint beam states, and:
wherein the two or more downlink beam states or the two or more joint beam states belong to a same beam state or a same quasi colocation (QCL) property,
wherein a first downlink beam state of the two or more downlink beam states or a first joint beam state of the two or more joint beam states is applied to downlink, or
wherein one or more second downlink beam states of the two or more downlink beam states or one or more second joint beam states of the two or more joint beam states are ignored or not applied to downlink.

17. The apparatus of claim 15,
wherein the at least one beam state from the one or more beam states comprises a joint beam state or an uplink beam state, and
wherein the reference signal comprises a sounding reference signal (SRS).

18. The apparatus of claim 15,
wherein the reference signal comprises a sounding reference signal (SRS) associated with a separate closed loop in a component carrier, and
wherein the method further comprises:
receiving, by the communication device, a control information, wherein the control information includes a transmission power command (TPC) for the SRS, wherein the transmission power of the SRS in the component carrier is determined according to the TPC.

19. The apparatus of claim 18,
wherein a physical uplink shared channel (PUSCH) is configured in the component carrier, or
wherein one field in the control information indicates a closed-loop index for the TPC.

20. The apparatus of claim 18,
wherein a mode indicating that a single downlink beam state and one or more uplink beam states are indicated is enabled,
wherein an index of the separate closed loop is configured per SRS resource set, or
wherein the SRS is associated with the separate closed loop that is separated from that of a physical uplink shared channel (PUSCH).
